(19) United States
(12) Patent Application Publication
(10) Pub. No.: US 2012/0044787 A1
(43) Pub. Date: Feb. 23, 2012

(54) Stepping motor control circuit and analogue electronic watch

(76) Inventors: Saburo Manaka, Chiba-shi (JP); Akira Takakura, Chiba-shi (JP); Keishi Honmura, Chiba-shi (JP); Kosuke Yamamoto, Chiba-shi (JP); Kazumi Sakumoto, Chiba-shi (JP); Kenji Ogasawara, Chiba-shi (JP); Hiroshi Shimizu, Chiba-shi (JP)

(21) Appl. No.: 13/136,971

(22) Filed: Aug. 16, 2011

(30) Foreign Application Priority Data
Aug. 19, 2010 (JP) 2010-184238
Jun. 2, 2011 (JP) 2011-124451

(51) Int. Cl. H02P 8/26; G04C 3/14

(52) U.S. Cl. 368/80; 318/696

(57) ABSTRACT

The invention is intended to achieve detection of a source voltage without providing a voltage detection circuit and allow a drive stop while holding correct drive pulse information when the source voltage is lowered to a predetermined level or below. A detection segment for detecting the state of rotation of a stepping motor is divided into a plurality of segments and, when a pattern of an induced signal detected in the respective segments is a pattern which indicates that the voltage of a secondary battery is lowered to the predetermined voltage or below, the control circuit memorizes a polarity of the drive pulse used in the last driving in a polarity memory and stops the driving of the stepping motor. When the voltage of the secondary battery is restored to the predetermined voltage or higher, the driving is restarted by a main drive pulse having a polarity opposite from the polarity memorized in the polarity memory.

### BACKGROUND OF THE INVENTION

1. Field of the Invention

The present invention relates to a stepping motor control circuit and an analogue electronic watch using the stepping motor control circuit.

2. Description of the Related Art

In the related art, a stepping motor including a stator having a rotor storage through hole and a positioning portion for determining a stop position of a rotor, the rotor disposed in the rotor storage through hole, and a coil, and being configured to rotate the rotor by causing the stator to generate a magnetic flux by supplying alternating signals to the coil and stop the same at a position corresponding to the positioning portion is used in an analogue electronic watch, for example.

A method employed as a method of controlling the stepping motor is a correction drive system configured to detect whether or not the stepping motor is rotated by detecting an induced signal generated in the stepping motor when the stepping motor is driven by a main drive pulse P1 and, according to the result of detection of whether or not the stepping motor is rotated, change the pulse width of the main drive pulse P1 and drive the stepping motor by the changed main drive pulse P1 or forcedly rotate the stepping motor by a correction drive pulse P2 having a pulse width larger than that of the main drive pulse P1 (for example, JP-B-61-15385).

WO2005/119377 discloses a device for comparatively discriminating a detected time and a reference time in addition to the detection of the induced signal when detecting the rotation of the stepping motor. If the detected signal is lower than a predetermined reference threshold voltage Vcomp after having rotated the stepping motor by a main drive pulse P11, the correction drive pulse P2 is supplied, and the subsequent main drive pulse P1 is changed to a main drive pulse P12 having a larger energy than the main drive pulse P11 for driving the stepping motor (pulse up). If the detected time of the rotation by the main drive pulse P12 is earlier than the reference time, the main drive pulse P12 is changed to the main drive pulse P11 (pulse down), so that the stepping motor is rotated by the main drive pulse P1 according to the load generated during the driving and hence the power consumption is reduced.

In contrast, in the invention described in JP-A-62-194484, there is provided a device which changes its clocking cycle to move a second hand by two seconds at a time (to move the second hand by two seconds at a time twice consecutively) to notify a user of an electric charge shortage when the voltage of a secondary battery used as a power source is lowered and, when the driving of the stepping motor is stopped, memorizes drive pulse information when the operation is stopped. However, since a voltage detection circuit is employed, there is a problem of complex configuration. In addition, in an electronic watch having a secondary battery as represented by a solar energy powered watch, a stop of clocking resulted from lowering of source voltage of a movement may be performed in a state in which clocking is unstable due to variations of the movement, so that there is a risk of erroneous memorization of drive pulse information when the clocking is stopped. If the incorrect drive pulse information is memorized, normal driving cannot be restored when the clocking is once stopped due to the lowering of the source voltage and then is restarted by the recovery of the power source.

### SUMMARY OF INVENTION

It is an aspect of the present application to achieve detection of a source voltage without providing a voltage detection circuit and allow a drive stop while holding correct drive pulse information when the source voltage is lowered to a predetermined level or below.

According to the application, there is provided a stepping motor control circuit including: a power source; a rotation detection device configured to detect an induced signal generated by the rotation of a rotor of a stepping motor and detect the state of rotation of the stepping motor according to whether or not the induced signal exceeds a predetermined reference threshold voltage in a predetermined detection segment; and a drive control device configured to select any one of drive pulses having energies different from each other according to the result of detection detected by the rotation detection device and control the driving of the stepping motor with a predetermined polarity, wherein the detection segment is divided into a plurality of detection segments, and the drive control device controls to stop the driving of the stepping motor in a state in which the polarity of the drive pulse to be used for restarting the driving after the voltage of the power source is restored to a voltage exceeding the predetermined voltage is known when the power source is determined to be lowered to a predetermined voltage value or below on the basis of a pattern of the segments in which the rotation detection device detects the induced signal exceeding the predetermined reference threshold voltage when the stepping motor is driven by the drive pulse having a predetermined energy.

According to an analogue electronic watch in the embodiment of the application, the analogue electronic watch includes the stepping motor configured to rotate time-of-day hands and a stepping motor control circuit configured to control the stepping motor and is characterized in that the stepping motor control circuit is employed as the stepping motor control circuit.

The motor control circuit according to the application enables detection of a source voltage without providing a voltage detection circuit and allows a drive stop while holding correct drive pulse information when the source voltage is lowered to a predetermined level or below.

According to the analogue electronic watch in the application, since the source voltage can be detected without providing the voltage detection circuit and the driving can be stopped in a state of holding the correct drive pulse information when the source voltage is lowered to the predetermined voltage or below, the driving can be started by the correct drive pulse when the source voltage is restored, so that correct clocking is achieved.

### BRIEF DESCRIPTION OF THE DRAWINGS

FIG. 1 is a block diagram showing a stepping motor control circuit and an analogue electronic watch according to a first embodiment of the invention;

FIG. 2 is a configuration drawing of a stepping motor used in respective embodiments of the invention;

FIG. 3 is a timing chart for explaining actions in the respective embodiments of the invention;

FIG. 4 is a determination chart for explaining the actions in the respective embodiments of the invention;

FIG. 5 is a flowchart showing an action in the first embodiment of the invention;

FIG. 6 is a block diagram showing a stepping motor control circuit and an analogue electronic watch according to a second embodiment of the invention;

FIG. 7 is a flowchart showing an action in the second embodiment of the invention;

FIG. 8 is a block diagram showing a stepping motor control circuit and an analogue electronic watch according to a third embodiment of the invention;

FIG. 9 is a flowchart showing an action in the third embodiment of the invention;

FIG. 10 is a block diagram showing a stepping motor control circuit and an analogue electronic watch according to a fourth embodiment of the invention; and

FIG. 11 is a flowchart showing an action in the fourth embodiment of the invention.

### DESCRIPTION OF THE PREFERRED EMBODIMENTS

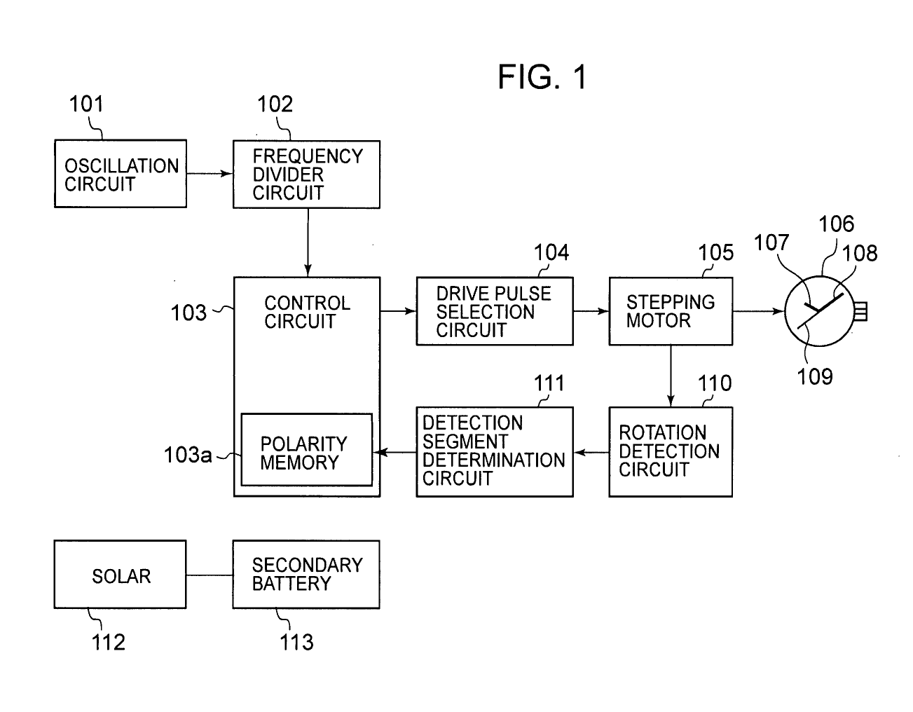

FIG. 1 is a block diagram of an analogue electronic watch using a stepping motor control circuit according to a first embodiment of the invention, and shows an example of an analogue electronic wrist watch.

In FIG. 1, the analogue electronic watch includes an oscillation circuit 101 configured to generate signals of a predetermined frequency, a frequency divider circuit 102 configured to divide the frequency of the signals generated by the oscillation circuit 101 and generate a time signal which serves as a reference when counting the time, a control circuit 103 configured to perform control of respective electronic circuit elements which constitute the electronic watch and control of drive pulse change, a drive pulse selection circuit 104 configured to select and output a drive pulse for rotating a motor on the basis of a control signal from the control circuit 103, a stepping motor 105 configured to be rotated by the drive pulse from the drive pulse selection circuit 104, and an analogue display unit 106 configured to be rotated by the stepping motor 105 which includes time-of-day hands indicating the time of day (three types; namely, an hour hand 107, a minute hand 108, and a second hand 109 in an example shown in FIG. 1).

The analogue electronic watch also includes a rotation detection circuit 110 configured to detect induced signals VRs representing the state of rotation of the stepping motor 105 in a predetermined detection segment, and a detection segment determination circuit 111 configured to compare a time and a segment where the rotation detection circuit 110 detects the induced signal VRs exceeding a predetermined reference threshold voltage Vcomp and determine the segment where the induced signal VRs is detected. As described later, the detection segment for detecting whether or not the stepping motor 105 is rotated is divided into three segments.

The analogue electronic watch includes a solar energy generation element 112 configured to receive light and generate electricity and a secondary battery 113 which is charged by the solar photovoltaic element 112 and serves as a power source for supplying a drive power to the respective electronic circuit elements 101 to 105, 110, and 111 of the analogue electronic watch.

The control circuit 103 controls the stepping motor 105 so as to be driven alternately by main drive pulses P1 having different polarities in a state in which the stepping motor 105 rotates normally, and hence includes a polarity memory 103a configured to memorize a polarity currently used for driving the stepping motor 105 as polarity information for determining the polarity for the next driving every time when the stepping motor 105 is driven. For the driving using the main drive pulse P1 for the next time, the control circuit 103 drives the stepping motor 105 by a main drive pulse P1 having a polarity opposite from that memorized in the polarity memory 103a, and memorizes the polarity of the main drive pulse P1 used at that time in the polarity memory 103a as the polarity information.

It is also possible to memorize information on the polarity to be used in the next driving as the polarity information for determining the polarity used in the next driving. In this case, the control circuit 103 controls the stepping motor 105 to be driven by the main drive pulse P1 having the polarity memorized in the polarity memory 103a in the next driving, and memorizes the polarity information to be used for the subsequent driving in the polarity memory 103a as the polarity information.

The rotation detection circuit 110 has a configuration in which the induced signal VRs is detected using the same principle as the rotation detection circuit described in JP-B-61-15385, and the reference threshold voltage Vcomp is set as follows. When the speed of the rotation is high as in the case where the stepping motor 105 rotates, the induced signal VRs exceeding the predetermined reference threshold voltage Vcomp is generated, and when the speed of rotation is low as in the case where the motor 105 does not rotate, the induced signal VRs does not exceed the reference threshold voltage Vcomp.

The oscillation circuit 101 and the frequency divider circuit 102 constitute a signal generating device, and the analogue display unit 106 constitutes a time-of-day display device. The rotation detection circuit 110 constitutes a rotation detecting device, and the control circuit 103, the drive pulse selection circuit 104, the rotation detection circuit 110 and the detection segment determination circuit 111 constitute a drive control device. The polarity memory 103a constitutes the polarity information memory device.

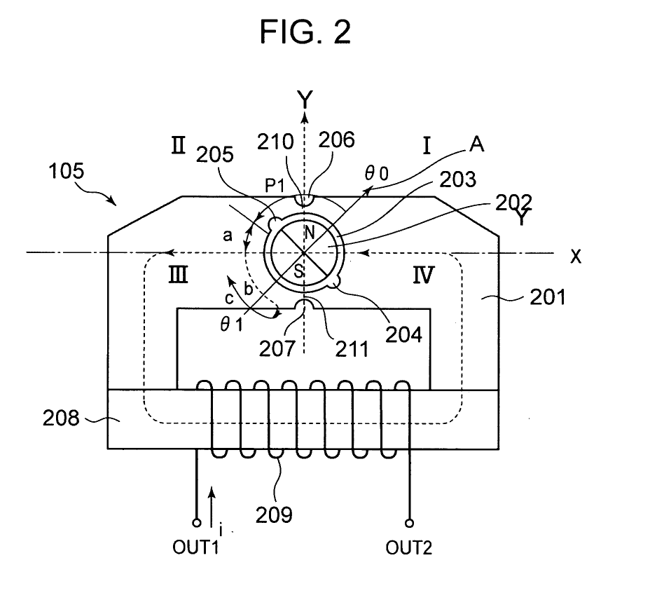

FIG. 2 is a configuration drawing of the stepping motor 105 which is used commonly in the respective embodiments of the invention, and shows an example of a stepping motor for a watch which is generally used in the analogue electronic watch.

In FIG. 2, the stepping motor 105 includes a stator 201 having a rotor storage through hole 203, a rotor 202 disposed in the rotor storage through hole 203 so as to be capable of rotating therein, a magnetic core 208 joined to the stator 201, and a coil 209 wound around the magnetic core 208. When the stepping motor 105 is used in the analogue electronic watch, the stator 201 and the magnetic core 208 are fixed to a base panel (not shown) with screws (not shown) and are joined to each other. The coil 209 has a first terminal OUT1 and a second terminal OUT2.

The rotor 202 is magnetized in two polarities (S-polar and N-polar). A plurality of (two in this embodiment) notched portions (outer notches) 206 and 207 are provided on outer end portions of the stator 201 formed of a magnetic material at positions opposing to each other with the intermediary of the rotor storage through hole 203. Provided between the respective outer notches 206 and 207 and the rotor storage through hole 203 are saturable portions 210 and 211.

The saturable portions 210 and 211 are configured not to be magnetically saturated by a magnetic flux of the rotor 202 and to be magnetically saturated when the coil 209 is excited so that the magnetic resistance is increased. The rotor storage through hole 203 is formed into a circular hole shape having a plurality of (two in this embodiment) semicircular notched portions (inner notches) 204 and 205 integrally formed at opposed portions of the through hole having a circular contour.

The notched portions 204 and 205 constitute positioning portions for positioning a stop position of the rotor 202. In a state in which the coil 209 is not excited, the rotor 202 is stably stopped at a position corresponding to the above-described positioning portions, in other words, at a position (at an angular position θ0) where the direction of an axis of magnetic pole A of the rotor 202 extends orthogonally to a segment connecting the notched portions 204 and 205 as shown in FIG. 2. An XY-coordinate space extending around an axis of rotation (center of rotation) of the rotor 202 as a center is divided into four quadrants (first to fourth quadrants I to IV).

When the drive pulse selection circuit 104 supplies a rectangular drive pulse to between the terminals OUT1 and OUT2 of the coil 209 (for example, the first terminal OUT1 side is the positive pole and the second terminal OUT2 side is the negative pole), and allows an electric current i to flow in the direction indicated by an arrow in FIG. 2, a magnetic flux in the direction of an arrow of a broken line is generated in the stator 201. Accordingly, the saturable portions 210 and 211 are saturated and the magnetic resistance is increased, and then the rotor 202 rotates in the direction indicated by an arrow in FIG. 2 by 180° by a mutual action between a magnetic pole generated in the stator 201 and a magnetic pole of the rotor 202, and the axis of magnetic pole stops stably at an angular position θ1. The direction of rotation (counterclockwise rotation in FIG. 2) for causing the stepping motor 105 to rotate and putting the same into a normal action (the movement of the time-of-day hands because the watch in this embodiment is an analogue electronic watch) is defined to be a normal direction and the reverse direction (clockwise direction) is defined to be a reverse direction.

Subsequently, when the drive pulse selection circuit 104 supplies square-wave drive pulses having an opposite polarity to the terminals OUT1 and OUT2 of the coil 209 (the first terminal OUT1 side is the negative pole and the second terminal OUT2 side is the positive pole, so that the polarity is inverted from the driving described above), and allows an electric current to flow in the direction opposite from that indicated by an arrow in FIG. 2, a magnetic flux is generated in the stator 201 in the opposite direction from that indicated by an arrow of a broken line. Accordingly, the saturable portions 210 and 211 are saturated first, and then the rotor 202 rotates in the same direction (normal direction) as that described above by 180° by the mutual action between the magnetic pole generated in the stator 201 and the magnetic pole of the rotor 202, and the axis of magnetic pole stops stably at the angular position θ0.

In this manner, by supplying the signals having different polarities (alternating signals) to the coil 209, the operation is repeatedly performed, so that the rotor 202 is rotated continuously in the direction indicated by an arrow by 180° each. In this embodiment, a plurality of main drive pulses P10 to P1n having energies different from each other and a correction drive pulse P2 having energy larger than the respective main drive pulses P1 are used as the drive pulses as described later.

The control circuit 103 basically drives the stepping motor 105 to rotate by driving by the main drive pulses P1 having polarities different from each other alternately and, when the rotation cannot be achieved by the main drive pulse P1, drives the stepping motor 105 to rotate by the correction drive pulse P2 having the same polarity as the corresponding main drive pulse P1. However, in the respective embodiments in the invention, driving is also performed in different modes.

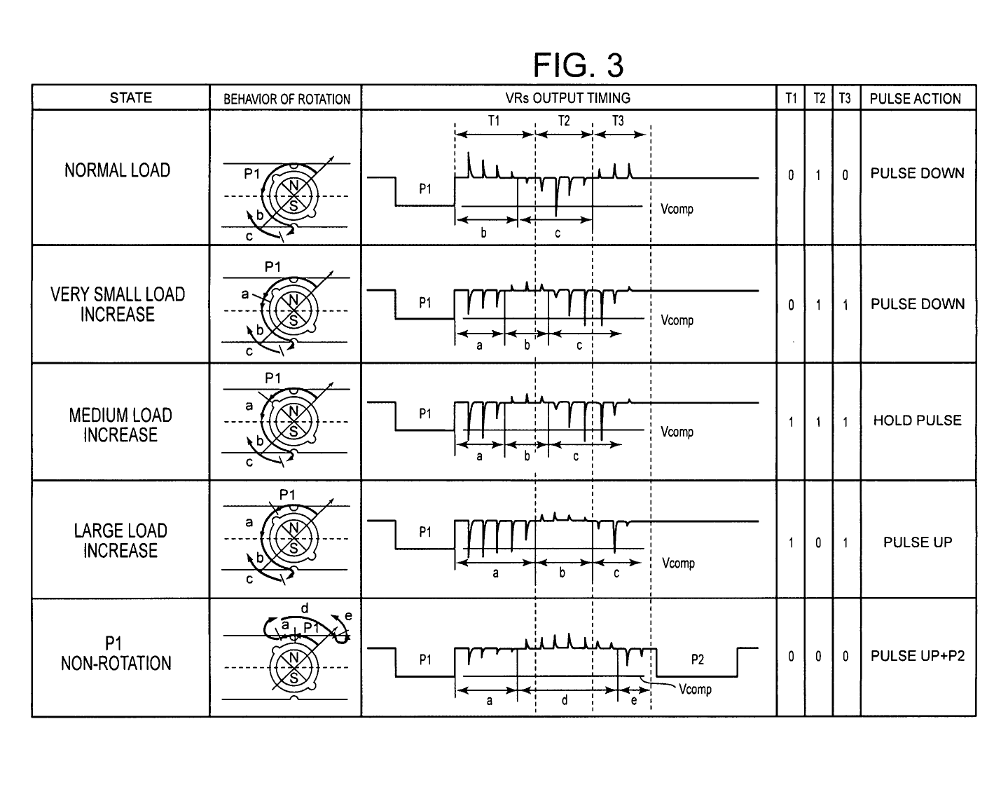

FIG. 3 is a timing chart when the stepping motor 105 is driven by the main drive pulse P1 in the respective embodiments of the invention, and also shows patterns and pulse control actions indicating magnitudes of the load, and rotational positions and the state of rotation of the rotor 202.

In FIG. 3, reference sign P1 designates the main drive pulse P1 and also a segment in which the rotor 202 is rotated by the main drive pulse P1. Reference signs a to e designate areas showing the rotational positions of the rotor 202 due to free vibrations after the stop of drive by the main drive pulse P1.

A predetermined time immediately after the drive by the main drive pulse P1 is designated as a first segment T1, a predetermined time after the first segment T1 is designated as a second segment T2, and a predetermined time after the second segment T2 is designated as a third segment T3. In this manner, an entire detection segment T starting from a timing immediately after the drive by the main drive pulse P1 is divided into a plurality of segments (in this embodiment, three segments T1 to T3). In this embodiment, a mask segment, which is a segment in which the induced signal VRs is not detected, is not provided.

When the XY-coordinate space where a main magnetic pole of the rotor 202 is situated by its rotation is divided into first to fourth quadrants I to IV about the rotor 202, the first to third segments T1 to T3 can be expressed as follows.

In other words, in the state of the normal load, the first segment T1 corresponds to a segment in which the state of rotation of the rotor 202 in the normal direction is determined and a segment in which the first state of rotation in the reverse direction is determined in the third quadrant III of the space around the rotor 202, the second segment T2 corresponds to a segment in which the first state of rotation of the rotor 202 in the reverse direction is determined in the third quadrant III, and the third segment T3 corresponds to a segment in which the state of rotation after the first rotation of the rotor 202 in the reverse direction is determined in the third quadrant III.

Here, the normal load means a load applied at the normal driving state, and in this embodiment, the normal load is defined to be a load applied at the time of driving the time-of-day hands (hour hand 107, minute hand 108, and second hand 109).

In the state in which the load is increased from the normal load by a very small amount (load increase is vary small), the first segment T1 corresponds to a segment for determining the state of rotation of the rotor 202 in the normal direction in the second quadrant II and the first state of rotation of the rotor 202 in the normal direction in the third quadrant III, the second segment T2 corresponds to a segment for determining the first state of rotation of the rotor 202 in the normal direction and the first state of rotation in the reverse direction in the third quadrant III, and the third segment T3 corresponds to a segment for determining the state of rotation after the first rotation of the rotor 202 in the reverse direction in the third quadrant III.

The reference threshold voltage Vcomp represents a reference threshold voltage for determining the voltage level of the induced signal VRs generating in the stepping motor 105. The reference threshold voltage Vcomp is set in such a manner that the induced signal VRs exceeds the reference threshold voltage Vcomp when the rotor 202 performs a certain fast action as in the case where the stepping motor 105 rotates, and the induced signal VRs does not exceed the reference threshold voltage Vcomp when the rotor 202 does not perform the certain fast action as in the case where the stepping motor 105 does not rotate.

For example, in FIG. 3, in the stepping motor control circuit according to this embodiment, the induced signal VRs generated in an area b in the state of normal load is detected in the first segment T1, the induced signal VRs generated in an area c is detected in the first segment T1 and the second segment T2, and the induced signal VRs generated after the area c is detected in the third segment T3.

The case where the rotation detection circuit 110 detects the induced signal VRs exceeding the reference threshold voltage Vcomp is expressed as a determination value “1”, and the case where the rotation detection circuit 110 cannot detect the induced signal VRs exceeding the reference threshold voltage Vcomp is expressed as a determination value “0”. In the example of the normal load driving shown in FIG. 3, a pattern (0, 1, 0) is obtained as a pattern indicating the state of rotation (the determination value in the first segment, the determination value in the second segment, and the determination value in the third segment). Therefore, the control circuit 103 determines that a driving energy is excessive (rotation with reserve), and performs pulse control to downgrade the driving energy of the main drive pulse P1 by a rank (pulse down).

In the state in which the load increase is very small, the induced signal VRs generated in an area a is detected in the first segment T1, the induced signal generated in the area b is detected in the first segment T1 and the second segment T2, and the induced signal generated in the area c is detected in the second segment T2 and the third segment T3. In the example shown in FIG. 3, a pattern (0, 1, 1) is obtained. Therefore, the control circuit 103 determines that it is a rotation with reserve as described above and performs the pulse control so as to downgrade the driving energy of the main drive pulse P1 by a rank.

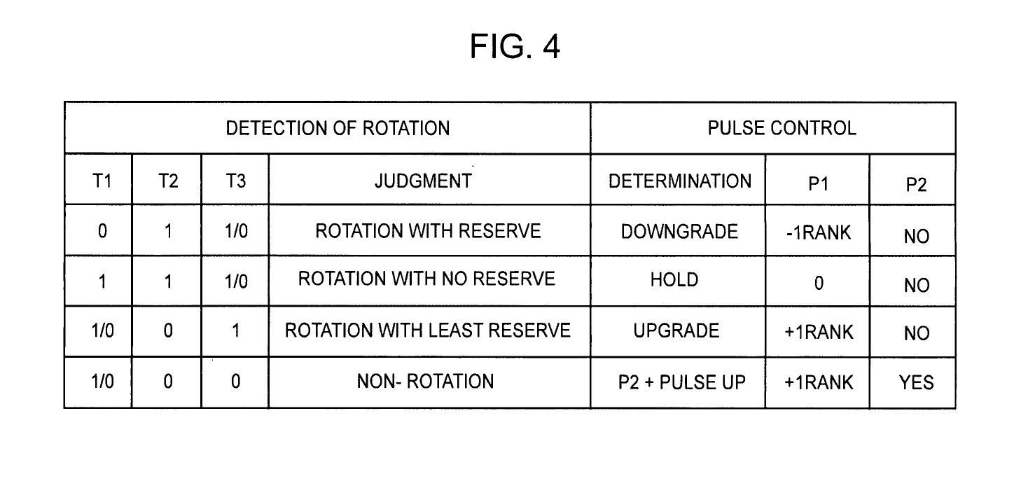

FIG. 4 is a determination chart showing all the actions in the respective embodiments of the invention. In FIG. 4, as described above, the case where the induced signal VRs exceeding the reference threshold voltage Vcomp is detected is expressed as the determination value “1”, and the case where the induced signal VRs exceeding the reference threshold voltage Vcomp cannot be detected is expressed as the determination value “0”. The expression “1/0” means that the determination values “1” and “0” are both applicable.

As shown in FIG. 4, the rotation detection circuit 110 detects the presence or absence of the induced signal VRs exceeding the reference threshold voltage Vcomp. Then, the detection segment determination circuit 111 references the determination chart in FIG. 4 stored in the control circuit 103 on the basis of a pattern of determination of a detection timing of the induced signal VRs. The control circuit 103 and the drive pulse selection circuit 104 control the rotation of the stepping motor 105 by performing the drive pulse control such as upgrade or downgrade for the main drive pulse P1, or the driving by the correction drive pulse P2, described later.

For example, in the case of a pattern (1/0, 0, 0), the control circuit 103 determines that the stepping motor 105 is not rotating (non-rotation), and controls the drive pulse selection circuit 104 so as to drive the stepping motor 105 by the correction drive pulse P2, and then controls the drive pulse selection circuit 104 so as to drive the stepping motor 105 next time by the main drive pulse P1 which is upgraded by a rank.

In the case of a pattern (1/0, 0, 1), the control circuit 103 determines that the stepping motor 105 rotates but is in the state with a load increased by a large amount from the normal load (load increase is large) and hence the stepping motor 105 may become the non-rotatable state at the time of next driving (rotation with least energy). Accordingly, the control circuit 103 does not perform the driving by the correction drive pulse P2, but controls the drive pulse selection circuit 104 so as to drive the stepping motor 105 by the main drive pulse P1 upgraded by a rank at the time of next driving in advance.

In the case of a pattern (1, 1, 1/0), the control circuit 103 determines that the stepping motor 105 rotates, the load is being increased, and the driving energy is adequate (rotation without reserve), and controls the drive pulse selection circuit 104 so as to drive the stepping motor 105 without changing the main drive pulse P1 for the next driving.

In the case of a pattern (0, 1, 1/0), the control circuit 103 determines that the stepping motor 105 rotates and the load is the normal load or the load with very small amount of increase, and hence there is a reserve in the driving energy (rotation with reserve), and controls the drive pulse selection circuit 104 so as to drive the stepping motor 105 by the main drive pulse P1 degraded by a rank for the next driving.

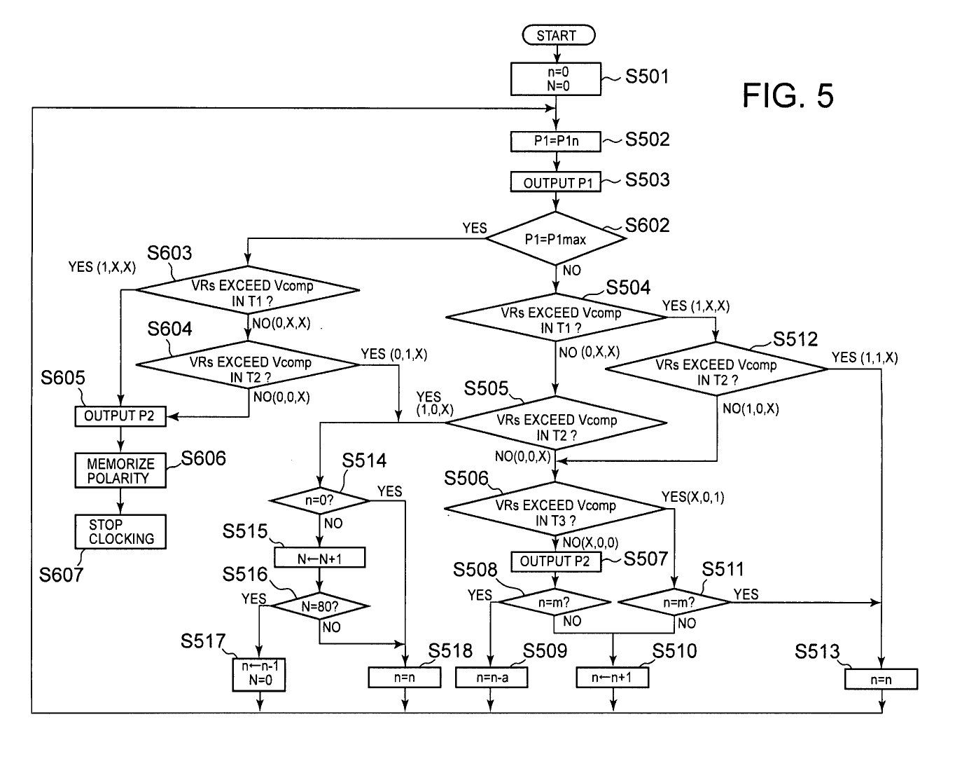

FIG. 5 is a flowchart showing the action of the stepping motor control circuit and the analogue electronic watch according to the first embodiment of the invention, and is a flowchart mainly showing a process in the control circuit 103.

Referring now to FIG. 1 to FIG. 5, the actions of the stepping motor control circuit and the analogue electronic watch according to the first embodiment of the invention will be described in detail.

In FIG. 1, the oscillation circuit 101 generates a reference clock signal of a predetermined frequency, and the frequency divider circuit 102 divides the signal generated by the oscillation circuit 101 and generates a time signal as a reference of time counting, and outputs the same to the control circuit 103.

The control circuit 103 counts the time signal and performs a time counting action. Then, the control circuit 103 firstly sets an energy rank n and the number of times N of the main drive pulse P1n to zero (Step S501 in FIG. 5), and then outputs a control signal to rotate the stepping motor 105 by the main drive pulse P10 by a minimum pulse width (Steps S502, S503).

The control circuit 103 at this time outputs the control signal so as to drive the stepping motor 105 by a main drive pulse P10 having a polarity opposite from the polarity of the polarity information memorized in the polarity memory 103a and memorizes the reverse polarity information in the polarity memory 103a as the polarity information. Accordingly, the polarity memory 103a rewrites the memorized polarity information from old polarity information used at the previous driving to polarity information having a polarity to be used for driving this time (the reverse polarity) and memorizes the same.

The drive pulse selection circuit 104 rotates the stepping motor 105 by the main drive pulse P10 having a polarity specified by the control signal in response to a control signal from the control circuit 103. The stepping motor 105 is rotated by the main drive pulse P10 and then rotates the time-of-day hands 107, 108, and 109. Accordingly, when the stepping motor 105 is normally rotated, the current time is always displayed by the time-of-day hands 107, 108, and 109 in the analogue display unit 106.

The control circuit 103 determines whether the energy rank n of the main drive pulse P1 is a main drive pulse P1max of a maximum rank m or not (Step S602).

If the energy rank n of the main drive pulse P1 is determined not to be the main drive pulse P1max of the maximum rank m in the process Step S602, the control circuit 103 performs determination whether or not the rotation detection circuit 110 detects the induced signal VRs of the stepping motor 105 exceeding the predetermined reference threshold voltage Vcomp, and whether or not the detection segment determination circuit 111 determines that a detected time t of the induced signal VRs falls within the segment T1 (that is, determination whether or not the induced signal VRs exceeding the reference threshold voltage Vcomp is detected within the first segment T1) (Step S504).

If the control circuit 103 determines that the induced signal VRs exceeding the reference threshold voltage Vcomp is not detected within the segment T1 in the process step S504 (It is a case of the pattern (0, x, x), provided that the determination value “x” means that the determination value may other be “1” or “0”). In the same manner, whether or not the induced signal VRs exceeding the reference threshold voltage Vcomp is detected within the segment T2 is determined (Step S505).

If the control circuit 103 determines that the induced signal VRs exceeding the reference threshold voltage Vcomp is not detected within the segment T2 in the process step S505 (It is a case of the pattern (0, 0, x)). In the same manner, whether or not the induced signal VRs exceeding the reference threshold voltage Vcomp is detected within the segment T3 is determined (Step S506).

If the control circuit 103 determines that the induced signal VRs exceeding the reference threshold voltage Vcomp is not detected within the segment T3 in the process step S506 (It is a case of the pattern (x, 0, 0), and the case of non-rotation in FIG. 3), the stepping motor 105 is driven by the correction drive pulse P2 having the same polarity as the main drive pulse P1 of the process step S503 (Step S507) and, if the rank n of the main drive pulse P1 is not the maximum rank m, the main drive pulse P1 is upgraded by a rank to a main drive pulse P1 (n+1). Then, the procedure goes back to the process step S502, and the main drive pulse P1 (n+1) is used for the next driving (Steps S508, S510).

If the rank n of the main drive pulse P1 is the maximum rank m in the process step S508, the control circuit 103 downgrades the main drive pulse P1 by a rank to a main drive pulse P1 (n−a) having a smaller energy by a predetermined amount. Then, the procedure goes back to the process step S502, and the main drive pulse P1 (n−a) is used for the next driving (Step S509). In this case, since the rotation is not possible even by the drive pulse P1max, which is the drive pulse having the maximum energy rank m in the main drive pulse P1, waste of energy caused by driving by the main drive pulse P1max having the maximum energy rank m for the next driving is avoided. At this time, the main drive pulse may be changed to the main drive pulse P10 having the minimum energy in order to achieve a high power-saving effect.

If the control circuit 103 determines that the induced signal VRs exceeding the reference threshold voltage Vcomp is detected within the segment T3 in the process step S506 (It is a case of the pattern (x, 0, 1)), when the rank n of the main drive pulse P1 is not the maximum rank m, the main drive pulse P1 is upgraded by a rank to a main drive pulse P1 (n+1). Then, the procedure goes back to the process step S502, and the main drive pulse P1 is used for the next driving (Steps S511, S510; which is a case where the load increase is large in FIG. 3).

If the rank n of the main drive pulse P1 is the maximum rank m in the process step S511, the control circuit 103 cannot change the rank, and hence the main drive pulse P1 is not changed. Then the procedure goes back to the process step S502, and this main drive pulse P1 is used for the next driving (Step S513).

If the control circuit 103 determines that the induced signal VRs exceeding the reference threshold voltage Vcomp is detected within the segment T1 in the process step S504 (It is a case of the pattern (1, x, x)), in the same manner, whether or not the induced signal VRs exceeding the reference threshold voltage Vcomp is detected within the segment T2 is determined (Step S512).

If the control circuit 103 determines that the induced signal VRs exceeding the reference threshold voltage Vcomp is not detected within the segment T2 in the process step S512 (It is a case of the pattern (1, 0, x)), the procedure goes to the process step S506 to perform the above-described process.

If the control circuit 103 determines that the induced signal VRs exceeding the reference threshold voltage Vcomp is detected within the segment T2 in the process step S512 (It is a case of the pattern (1, 1, x)), the procedure goes to the process step S513.

If the control circuit 103 determines that the induced signal VRs exceeding the reference threshold voltage Vcomp is detected within the segment T2 in the process step S505 (It is a case of the pattern (0, 1, x)), the rank cannot be downgraded if the rank n of the main drive pulse P1 is the lowest rank 0, and hence is maintained without change, then the procedure goes back to the process step S502 (Step S514 and S518).

If the control circuit 103 determines that the rank n of the main drive pulse P1 is not the lowest rank 0 in the process step S514, the control circuit 103 increments the number of times of continuous occurrence N by one (Step S515), and determines whether or not the number of times N reaches a predetermined number of times (eighty times in this embodiment) (Step S516). If the predetermined number of times is not reached, the procedure goes back to the process step S502 without changing the rank of the main drive pulse P1 (Step S518), and if the predetermined number of times is reached, the rank of the main drive pulse P1 is downgraded by a rank, the number of times of continuous occurrence N is reset to “0”, and the procedure goes back to the process step S502 (Step S517).

In contrast, if the control circuit 103 determines that the main drive pulse P1 is the main drive pulse having the predetermined energy (the main drive pulse P1max whose energy rank n is the maximum rank m in this embodiment) in the process Step S602, whether or not the induced signal VRs exceeding the reference threshold voltage Vcomp is detected in the first segment T1 is determined (Step S603).

If the control circuit 103 determines that the induced signal VRs exceeding the reference threshold voltage Vcomp is not detected within the segment T1 in the process step S603 (It is a case of the pattern (0, x, x)), whether or not the induced signal VRs exceeding the reference threshold voltage Vcomp is detected within the segment T2 is determined (Step S604).

If the control circuit 103 determines that the induced signal VRs exceeding the reference threshold voltage Vcomp is detected within the segment T2 in the process Step S604, procedure goes to the process Step S514.

If the control circuit 103 determines that the induced signal VRs exceeding the reference threshold voltage Vcomp is not detected within the segment T2 in the process step S604 (It is a case of the pattern (0, 0, x)), it is determined that the voltage of the secondary battery 113 is lowered to a predetermined value or below, the control circuit 103 drives the stepping motor 105 by the correction drive pulse P2 (the correction drive pulse P2 having the same polarity as the main drive pulse P1 used for driving this time (the main drive pulse P1 in the process step S503)) to rotate the stepping motor 105 (Step S605). Accordingly, even when the stepping motor 105 is not rotated in the process Step S503 because the voltage of the secondary battery 113 is low, the stepping motor 105 can be rotated for sure.

Subsequently, the control circuit 103 memorizes the polarity of the correction drive pulse P2 used for driving this time (the same polarity as that of the main drive pulse P1 used for driving this time) in the polarity memory 103a as the polarity information (Step S606), stops the driving of the stepping motor 105, and stops the clocking (Step S607). Accordingly, the stepping motor 105 is brought into a sleep state.

Also, if the control circuit 103 determines that the induced signal VRs exceeding the reference threshold voltage Vcomp is detected within the segment T1 in the process step S603 (It is a case of the pattern (1, x, x)), it is determined that the source voltage of the secondary battery 113 is lowered to a predetermined value or below, the processes from the process step S605 onward are performed in the same manner as described above, and the control circuit 103 memorizes the polarity of the correction drive pulse P2 used for driving this time in the polarity memory 103a as the polarity information (Step S606), stops the driving of the stepping motor 105, and stops the clocking (Step S607). Accordingly, the stepping motor 105 is brought into the sleep state.

When the secondary battery 113 is charged by the solar photovoltaic element 112, and hence the control circuit 103 determines that the voltage of the secondary battery 113 is increased to the predetermined voltage or higher sufficient for the stable driving, the control circuit 103 references the polarity information memorized in the polarity memory 103a and restarts driving by the main drive pulse P1 having the polarity opposite from the polarity information.

As described thus far, the stepping motor control circuit according to the first embodiment of the invention includes the power source (the secondary battery 113 in this embodiment), the rotation detection device configured to detect the induced signal VRs generated by the rotation of the rotor 202 of the stepping motor 105 and detect the state of rotation of the stepping motor 105 depending on whether or not the induced signal VRs exceeds the predetermined reference threshold voltage Vcomp in the predetermined detection segment T, and the drive control device configured to select either the drive pulse P1 or P2 having energies different from each other according to the result of detection detected by the rotation detection device and control the driving of the stepping motor 105 with the predetermined polarity, and is characterized in that the detection segment T is divided into a plurality of segments (three segments T1 to T3 in this embodiment), and the drive control device controls to stop the driving of the stepping motor 105 in a state in which the polarity of the drive pulse to be used for restarting the driving after the voltage of the power source is restored to the voltage exceeding the predetermined voltage is known when the power source is determined to be lowered to the predetermined voltage value or below on the basis of the pattern of the segments in which the rotation detection device detects the induced signal VRs exceeding the reference threshold voltage Vcomp when the stepping motor 105 is driven by the drive pulse having the predetermined energy (the main drive pulse P1max of the maximum energy rank m in this embodiment).

Also, when the voltage of the power source is determined to be lowered to the predetermined value or below, the drive control device memorizes the polarity information which decides the polarity of the drive pulse used when restarting the driving after the source voltage is restored in the polarity memory 103a, and restarts the driving of the stepping motor 105 by the drive pulse having the polarity decided using the polarity information when restarting the driving after the source voltage is restored.

When the stepping motor 105 is driven by the drive pulse having the predetermined energy, if it is determined that the voltage of the power source is lowered to the predetermined voltage value or below, which can hardly achieve the stable driving, that is, when the pattern of the induced signal VRs becomes the predetermined pattern (the pattern (1, x, x) or (0, 0, x) in this embodiment), the drive control unit determines that the voltage of the power source is lowered to the predetermined voltage value or below, and memorizes the polarity information and stops the driving.

Therefore, the stepping motor control circuit according to the first embodiment has a simple configuration because the source voltage can be detected without providing the voltage detection circuit, and can stop the driving in the state of holding accurate information of the drive pulse when the voltage of the secondary battery 113 is lowered to the predetermined voltage or below.

When the stepping motor 105 is driven by the drive pulse having the predetermined energy, if it is determined that the voltage of the power source is lowered to the predetermined voltage value or below which can hardly achieve the stable driving, the drive control unit memorizes the polarity information after having rotated for sure by the correction drive pulse P2, so that the correct polarity information can be memorized, and hence the driving can be started by the drive pulse having the correct polarity when restarting the driving.

The analogue electronic watch according to the first embodiment has a simple configuration because the source voltage can be detected without providing the voltage detection circuit and the driving can be stopped in a state of holding correct driving pulse information when the voltage of the secondary battery 113 is lowered to a predetermined voltage or below, so that the driving can be started by the correct drive pulse when the voltage of the secondary battery 113 is restored and hence correct clocking is advantageously achieved.

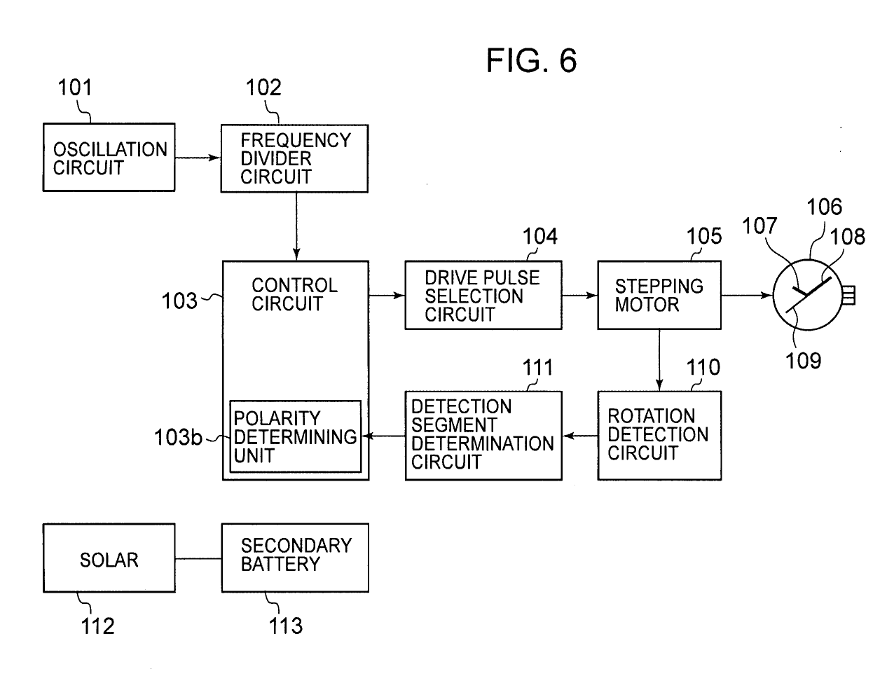

FIG. 6 is a block diagram of an analogue electronic watch using a motor control circuit according to a second embodiment of the invention showing an example of an analogue electronic wrist watch and the same components as in FIG. 1 are designated by the same reference numerals.

In FIG. 6, the control circuit 103 includes a polarity determining unit 103b which constitutes a polarity determining device. The polarity determining unit 103b has a function to determine the polarity of the correction drive pulse P2 when driven by the correction drive pulse P2. When stopping the driving as a result of lowering of the voltage of the secondary battery 113, the control circuit 103 controls to stop driving forcedly after having performed the driving of the stepping motor 105 by the drive pulse having the predetermined polarity, which is specified in advance.

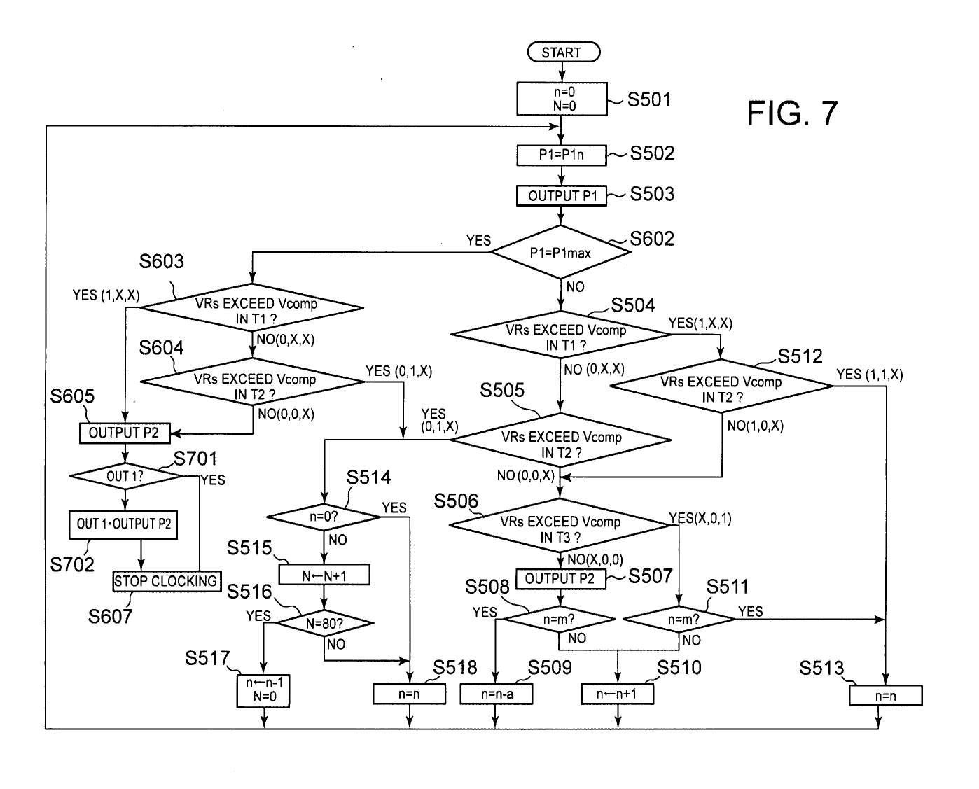

FIG. 7 is a flowchart showing the action of the stepping motor control circuit and the analogue electronic watch according to the second embodiment of the invention, and is a flowchart mainly showing the process in the control circuit 103, and the same components as in FIG. 5 are designated by the same reference numerals.

Referring now to FIG. 6, FIG. 7, FIG. and FIG. 2 to FIG. 4, the actions in the second embodiment different from the first embodiment will be described.

In FIG. 7, after the control circuit 103 determines that the voltage of the secondary battery 113 is lowered to the predetermined voltage or below by the pattern determination process in the process steps S603 and S604, and controls to drive the stepping motor 105 by the correction drive pulse P2 having the same polarity as the main drive pulse P1 in the process step S603 in the process step S605, the polarity determining unit 103b determines whether or not the polarity of the correction drive pulse P2 is a predetermined polarity OUT1 (Step S701).

If the polarity determining unit 103b determines that the polarity of the correction drive pulse P2 is the predetermined polarity OUT1 in the process step S701, the control circuit 103 stops the drive control of the stepping motor 105, and stops the clocking (Step S607). Accordingly, the stepping motor 105 is brought into the sleep state.

In contrast, if the polarity determining unit 103b determines that the polarity of the correction drive pulse P2 is not the predetermined polarity OUT1 in the process step S701 (in other words, it is an opposite polarity OUT2 of the predetermined polarity), the control circuit 103 controls to drive the stepping motor 105 by the correction drive pulse P2 of the predetermined polarity OUT1 (Step S702), and then stops the drive control of the stepping motor 105 and stops the clocking (Step S607). Accordingly, the stepping motor 105 is brought into the sleep state.

When the secondary battery 113 is charged by the solar photovoltaic element 112, and hence the control circuit 103 determines that the voltage of the secondary battery 113 is increased to the predetermined voltage or higher sufficient for the stable driving, and restarts driving by the main drive pulse P1 having the opposite polarity OUT2 opposite from the predetermined polarity OUT1.

As described thus far, according to the second embodiment of the invention, the voltage detection circuit is not necessary because whether or not the voltage of the power source is lowered to the predetermined voltage or below by the pattern of the induced signal VRs as in the first embodiment described above, so that the simple configuration is achieved.

Also, according to the second embodiment of the invention, when it is determined that the power source is lowered to the predetermined value or below, the drive control device controls to stop driving after having driven forcedly by the drive pulse having the predetermined polarity OUT1 and start the driving of the stepping motor 105 by the drive pulse having the opposite polarity OUT2 opposite from the predetermined polarity OUT1 when restarting the driving after the source voltage is restored, rotation of the stepping motor 105 is ensured when restarting the driving, and the reliable clocking is achieved.

Since the correction drive pulse P2 is used as the drive pulse having the predetermined polarity OUT1, rotation of the stepping motor 105 by driving with the predetermined polarity OUT1 is ensured, so that the stepping motor 105 can be rotated for sure when restarting the driving.

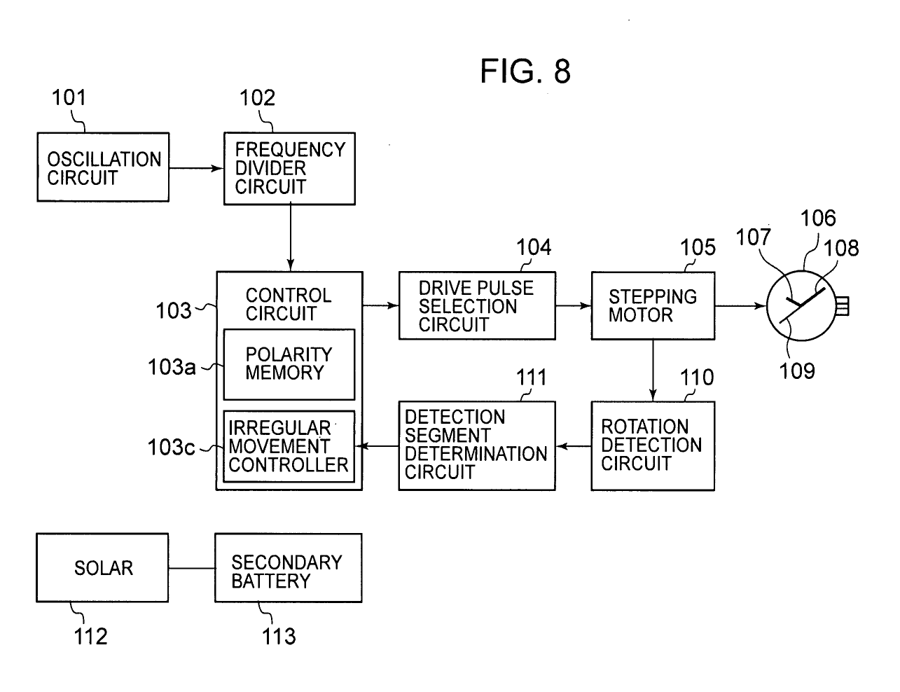

FIG. 8 is a block diagram of an analogue electronic watch using a motor control circuit according to a third embodiment of the invention showing an example of an analogue electronic wrist watch and the same components as in FIG. 1 are designated by the same reference numerals.

In FIG. 8, the control circuit 103 includes an irregular movement controller 103c which constitutes an irregular movement control device. The irregular movement controller 103c has a function to control the driving of the stepping motor 105 in a mode different from the mode at the time of normal driving when predetermined conditions such that the state of rotation of the stepping motor 105 becomes a predetermined state, which will be described in detail later. Here, the normal driving is an action to rotate the stepping motor 105 at a constant predetermined cycle so as to display the time of day by driving the time-of-day hands 107 to 109 to clock at a constant predetermined cycle (for example, one-second cycle). By driving the stepping motor 105 in a mode different from the mode at the time of normal driving, the time-of-day hands 107 to 109 perform clocking in a mode different from the normal driving. Accordingly, a notification such as the notification of necessity to charge the secondary battery 113 is performed.

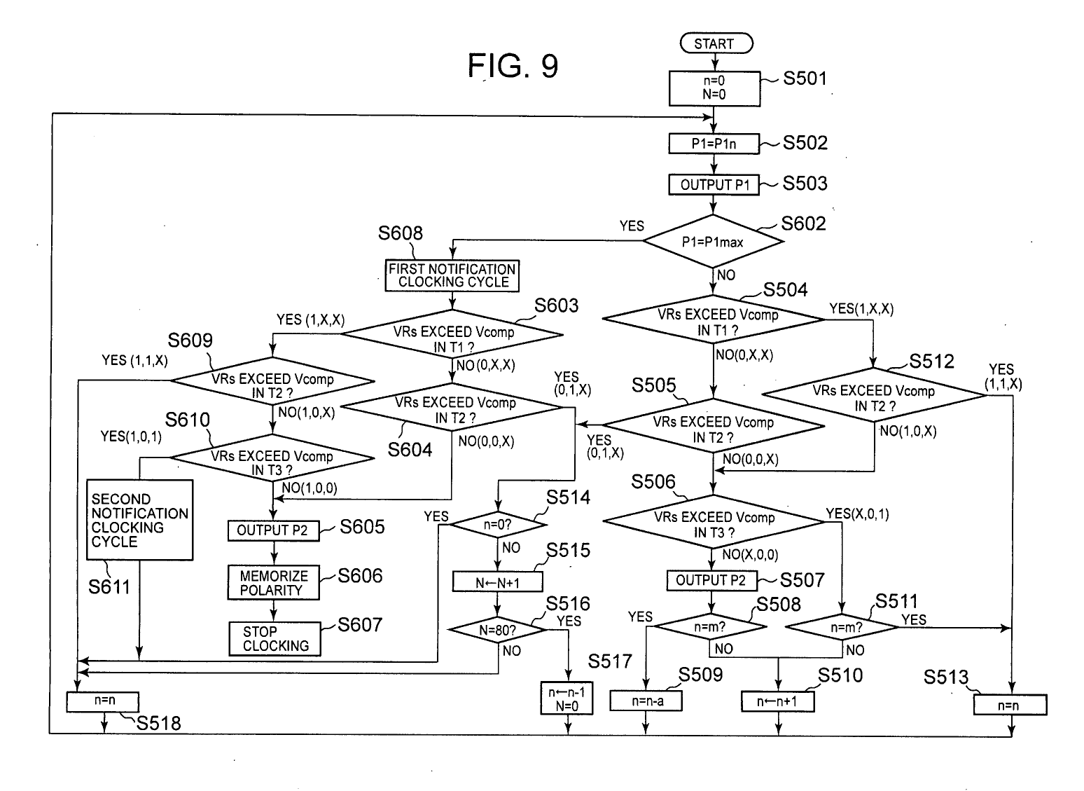

FIG. 9 is a flowchart showing the action of the stepping motor control circuit and the analogue electronic watch according to the third embodiment of the invention, and is a flowchart mainly showing the process in the control circuit 103, and the same components as in FIG. 5 are designated by the same reference numerals.

Referring now to FIG. 8, FIG. 9, and FIG. 2 to FIG. 4, the actions in the third embodiment of the invention different from the first embodiment will be described.

In the process step S602 shown in FIG. 9, when the control circuit 103 determines that the energy rank n of the main drive pulse P1 is the main drive pulse P1max of the maximum rank m, the irregular movement controller 103c outputs the control signal to the drive pulse selection circuit 104 so as to drive the stepping motor 105 to rotate in a driving mode in a first notification clocking cycle different from the mode at the time of normal driving (first mode) (Step S608).

The driving mode in the first notification clocking cycle is a driving action in a mode different from the mode at the time of normal driving, and in this embodiment, it is a driving mode which drives the stepping motor 105 to rotate by two seconds at a time at every two seconds (two seconds clocking). The drive pulse selection circuit 104 drives the stepping motor 105 to rotate by two seconds together at every two seconds in response to the control signal from the irregular movement controller 103c. Accordingly, the fact that a predetermined action (for example, charging) is necessary although it is not necessarily urgent is notified to the user. The main drive pulse P1 used for the driving at this time is the main drive pulse P1max whose energy rank n is the maximum rank m.

If the control circuit 103 determines that the induced signal VRs exceeding the reference threshold voltage Vcomp is not detected within the segment T1 in the process step S603 (It is a case of the pattern (0, x, x)), the procedure goes to the process step S604.

Also, if the control circuit 103 determines that the induced signal VRs exceeding the reference threshold voltage Vcomp is detected within the segment T1 in the process step S603 (It is a case of the pattern (1, x, x)), whether or not the induced signal VRs exceeding the reference threshold voltage Vcomp is detected within the segment T2 is determined (Step S609).

If the control circuit 103 determines that the induced signal VRs exceeding the reference threshold voltage Vcomp is not detected within the segment T2 in the process step S609 (It is a case of the pattern (1, 0, x)), whether or not the induced signal VRs exceeding the reference threshold voltage Vcomp is detected within the segment T3 is determined (Step S610).

If the control circuit 103 determines that the induced signal VRs exceeding the reference threshold voltage Vcomp is not detected within the segment T3 in the process step S610 (It is a case of the pattern (1, 0, 0)), the process in the process step S605 to S607 is performed.

Accordingly, even when the stepping motor 105 is not rotated in Step S608 because the voltage of the secondary battery 113 is low, the stepping motor 105 can be rotated for sure by the correction drive pulse P2 (Step S605). Also, the control circuit 103 memorizes the polarity of the correction drive pulse P2 used for driving this time (the same polarity as that of the main drive pulse P1 used for driving this time) in the polarity memory 103a as the polarity information (Step S606), stops the driving of the stepping motor 105, and stops the clocking (Step S607). Accordingly, the stepping motor 105 is brought into the sleep state.

Also, if the control circuit 103 determines that the induced signal VRs exceeding the reference threshold voltage Vcomp is detected within the segment T3 in the process step S610 (It is a case of “rotation with least energy having the pattern (1, 0, 1)), the irregular movement controller 103c outputs the control signal to the drive pulse selection circuit 104 so as to drive the stepping motor 105 to rotate in a driving mode in a second notification clocking cycle (second mode), and the procedure goes to the process step S518 (Step S611).

The second notification clocking cycle is a driving action in a mode different from the mode at the time of normal driving and the driving mode in the first notification clocking cycle (first mode), and in the third embodiment, it is a driving mode which drives the stepping motor 105 to rotate by three seconds at a time at every three seconds (three seconds clocking). Accordingly, the fact that a quick action is necessary (the voltage of the secondary battery 113 is significantly lowered, and the action such as charging is needed immediately) is notified to the user. The main drive pulse P1 used for the driving at this time is the main drive pulse P1max whose energy rank n is the maximum rank m.

Also, if the control circuit 103 determines that the induced signal VRs exceeding the reference threshold voltage Vcomp is detected within the segment T2 in the process step S609 (It is a case of the pattern (1, 1, x)), the procedure goes to the process step S518.

As described above, according to the third embodiment of the invention, not only the same effects as the first embodiment are achieved, but also the notification saying that the charging is necessary although it is not urgent can be given to the user because when the stepping motor 105 is driven by selecting the main drive pulse P1max having the maximum energy rank m, the stepping motor 105 is driven in the first mode, which is different from the mode at the time of normal driving while the stable rotation is performed.

Also, since the drive control device is configured to drive the stepping motor 105 in the second mode which is different from the mode at the time of normal driving and the first mode when a pattern in which the induced signal VRs exceeding the reference threshold voltage Vcomp is detected only in the first segment T1 and the third segment T3 is obtained when driving the stepping motor 105 by the main drive pulse P1max having the maximum energy rank m, the urgency when the voltage of the secondary battery 113 is significantly lowered can be notified to the user.

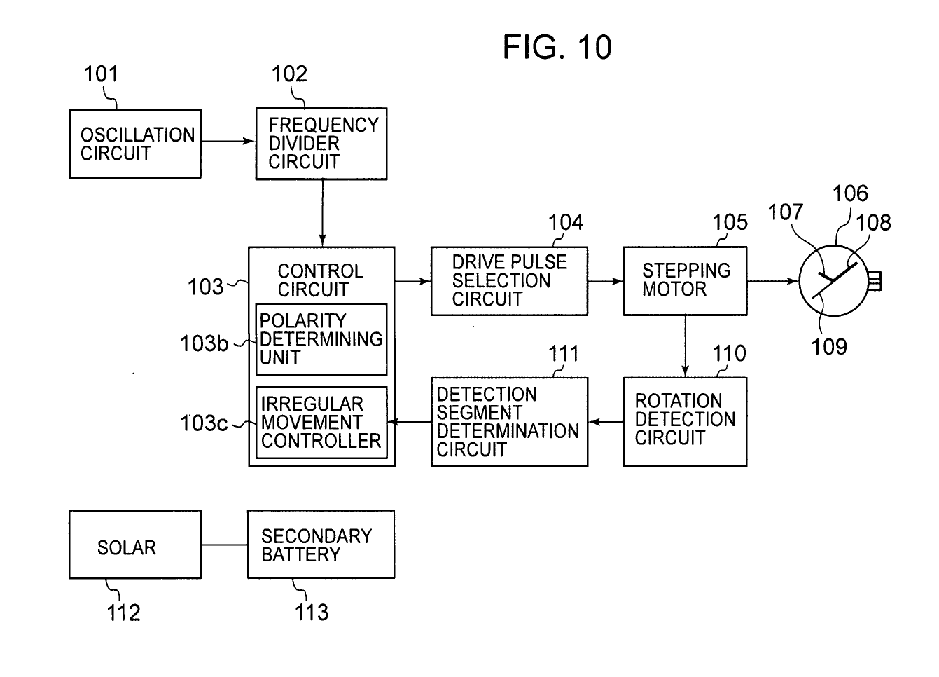

FIG. 10 is a block diagram of an analogue electronic watch using a motor control circuit according to a fourth embodiment of the invention showing an example of an analogue electronic wrist watch and the same components as in FIG. 6 and FIG. 8 are designated by the same reference numerals.

In FIG. 10, the control circuit 103 includes an irregular movement controller 103c which constitutes an irregular movement control device. In the same manner as the third embodiment, the irregular movement controller 103c has a function to control the driving of the stepping motor 105 in the first mode or the second mode different from the mode at the time of normal driving when the predetermined conditions such that the state of rotation of the stepping motor 105 becomes a predetermined state are satisfied. By driving the stepping motor 105 in a mode different from the normal driving, the time-of-day hands 107 to 109 perform clocking in the first mode or the second mode. Accordingly, a notifying action such as the notification of necessity to charge the secondary battery 113 is performed.

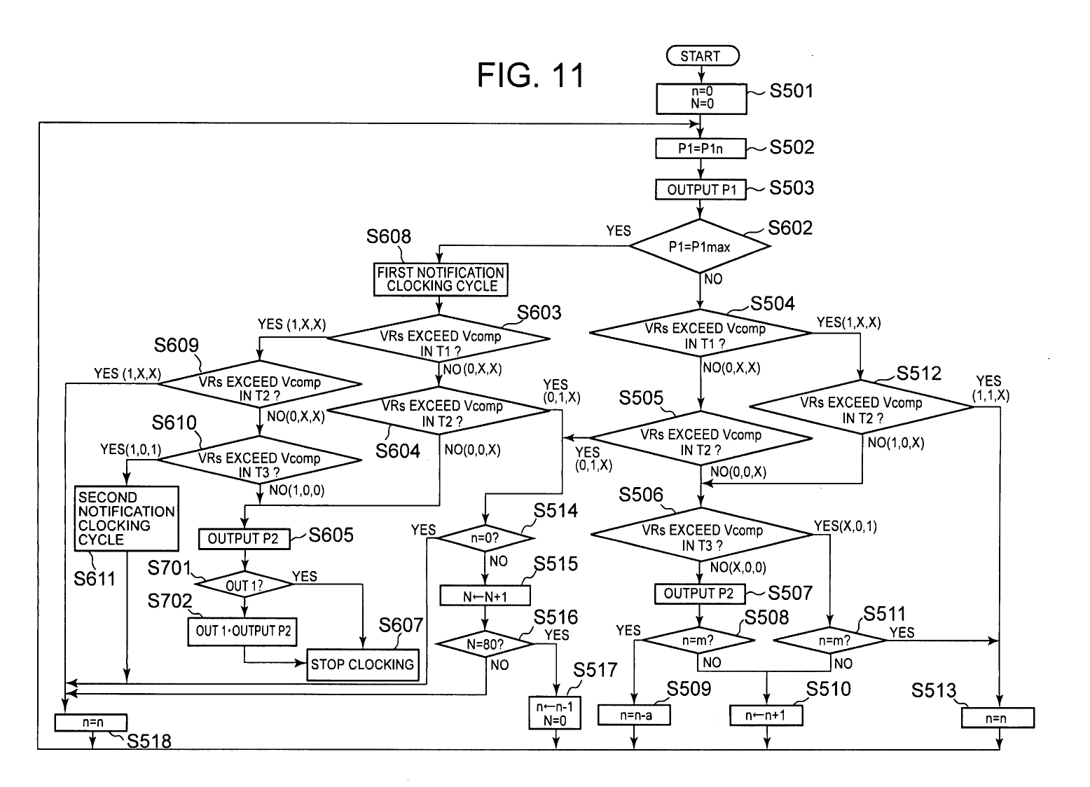

FIG. 11 is a flowchart showing the action of the stepping motor control circuit and the analogue electronic watch according to the fourth embodiment of the invention, and is a flowchart mainly showing the process in the control circuit 103, and the same components as in FIG. 7 and FIG. 9 are designated by the same reference numerals.

Referring now to FIG. 10, FIG. 11, and FIG. 2 to FIG. 4, the actions in the fourth embodiment of the invention different from the second embodiment will be described.

In the process step S602 shown in FIG. 11, when the control circuit 103 determines that the energy rank n of the main drive pulse P1 is the main drive pulse P1max of the maximum rank m, the irregular movement controller 103c outputs the control signal to the drive pulse selection circuit 104 so as to drive the stepping motor 105 to rotate in a driving mode in a first notification clocking cycle different from the mode at the time of normal driving (first mode) (Step S608).

The first notification clocking cycle is a driving action in a mode different from the mode at the time of normal driving in the same manner as the third embodiment described above, and in this embodiment, it is a driving mode which drives the stepping motor 105 to rotate by two seconds at a time at every two seconds (two seconds clocking). The drive pulse selection circuit 104 drives the stepping motor 105 to rotate by two seconds together at every two seconds in response to the control signal from the irregular movement controller 103c. Accordingly, the fact that a predetermined action (for example, charging) is necessary although it is not necessarily urgent is notified to the user.

The main drive pulse P1 used for the driving at this time is the main drive pulse P1max whose energy rank n is the maximum rank m.

If the control circuit 103 determines that the induced signal VRs exceeding the reference threshold voltage Vcomp is not detected within the segment T1 in the process step S603 (It is a case of the pattern (0, x, x)), the procedure goes to the process step S604.

Also, if the control circuit 103 determines that the induced signal VRs exceeding the reference threshold voltage Vcomp is detected within the segment T1 in the process step S603 (It is a case of the pattern (1, x, x)), whether or not the induced signal VRs exceeding the reference threshold voltage Vcomp is detected within the segment T2 is determined (Step S609).

If the control circuit 103 determines that the induced signal VRs exceeding the reference threshold voltage Vcomp is not detected within the segment T2 in the process step S609 (It is a case of the pattern (1, 0, x)), whether or not the induced signal VRs exceeding the reference threshold voltage Vcomp is detected within the segment T3 is determined (Step S610).

If the control circuit 103 determines that the induced signal VRs exceeding the reference threshold voltage Vcomp is not detected within the segment T3 in the process step S610 (It is a case of the pattern (1, 0, 0)), the process in the process steps S605, S607, S701, S702 is performed.

Accordingly, in the same manner as the second embodiment described above, the clocking is stopped after having driven to rotate by the correction drive pulse P2 having the predetermined polarity OUT1, and then the stepping motor 105 is brought into the sleep state.

Also, if the control circuit 103 determines that the induced signal VRs exceeding the reference threshold voltage Vcomp is detected within the segment T3 in the process step S610 (It is a case of “rotation with least energy having the pattern (1, 0, 1)), the irregular movement controller 103c outputs the control signal to the drive pulse selection circuit 104 so as to drive the stepping motor 105 to rotate in a driving mode in a second notification clocking cycle (second mode), and the procedure goes to the process step S518 (Step S611).

The second notification clocking cycle is a driving action in a mode different from the mode at the time of normal driving and the driving mode in the first notification clocking cycle (first mode), and as in the third embodiment, it is a driving mode which drives the stepping motor 105 to rotate by three seconds at a time at every three seconds (three seconds clocking). Accordingly, the fact that a quick action is necessary (the voltage of the secondary battery 113 is significantly lowered, and the action such as charging is needed immediately) is notified to the user. The main drive pulse P1 used for the driving at this time is the main drive pulse P1max whose energy rank n is the maximum rank m.

As described above, according to the fourth embodiment of the invention, in the same manner as the third embodiment, the notification saying that the charging is necessary although it is not urgent can be given to the user because when the stepping motor 105 is driven by selecting the main drive pulse P1max having the maximum energy rank m, the stepping motor 105 is driven in the first mode, which is different from the mode at the time of normal driving while the stable rotating state is performed.

Also, since the drive control device is configured to drive the stepping motor 105 in the second mode which is different from the mode at the time of normal driving and the first mode when a pattern in which the induced signal VRs exceeding the reference threshold voltage Vcomp is detected only in the first segment T1 and the third segment T3 is obtained when driving the stepping motor 105 by the main drive pulse P1max having the maximum energy rank m, the urgency when the voltage of the secondary battery 113 is significantly lowered can be notified to the user.

In the respective embodiments described above, the main drive pulse P1max having the maximum rank m is used as the drive pulse for determining whether the voltage of the secondary battery 113 is lowered to a predetermined voltage value or below. However, the drive pulse having other predetermined energy may be used.

Although the secondary battery 113 is exemplified as the power source in the respective embodiments, a primary battery is also applicable.

In the respective embodiments described above, the energy of the respective drive pulses is changed by differentiating the pulse width. However, the driving energy can be changed also by changing the number of comb-teeth pulses, or by changing the pulse voltage.

Also, although the analogue electronic watch has been described as the example of the application of the stepping motor, it may be applicable to electronic instruments which use the motor.

The stepping motor control circuit according to the invention may be applicable to various electronic instruments using the stepping motor.

The electronic watch according to the invention is applicable to various analogue electronic watches such as analogue electronic wrist watches with calendar function, or chronograph watches.

What is claimed is:

1. A stepping motor control circuit comprising:
a power source;
a rotation detection device configured to detect an induced signal generated by the rotation of a rotor of a stepping motor and detect the state of rotation of the stepping motor according to whether or not the induced signal exceeds a predetermined reference threshold voltage in a predetermined detection segment; and
a drive control device configured to select any one of drive pulses having energies different from each other according to the result of detection detected by the rotation detection device and control the driving of the stepping motor with a predetermined polarity, wherein
the detection segment is divided into a plurality of detection segments, and
the drive control device controls to stop the driving of the stepping motor in a state in which the polarity of the drive pulse to be used for restarting the driving after the voltage of the power source is restored to a voltage exceeding the predetermined voltage is known when the power source is determined to be lowered to a predetermined voltage value or below on the basis of a pattern of the segments in which the rotation detection device detects the induced signal exceeding the reference threshold voltage when the stepping motor is driven by the drive pulse having a predetermined energy.

2. The stepping motor control circuit according to claim 1, wherein when the voltage of the power source is determined to be lowered to the predetermined value or below, the drive control unit memorizes a polarity information which decides the polarity of the drive pulse used when restarting the driving after the source voltage is restored in a polarity information memory device, and starts the driving of the stepping motor by the drive pulse having the polarity decided using the polarity information when restarting the driving after the source voltage is restored.

3. The stepping motor control circuit according to claim 2, wherein when the voltage of the power source is determined to be lowered to the predetermined value or below, the drive control device memorizes the polarity of a correction drive pulse as the polarity information in the polarity information memory device after the having driven by the correction drive pulse having the same polarity as the drive pulse having the predetermined energy.

4. The stepping motor control circuit according to claim 1, wherein when the voltage of the power source is determined to be lowered to the predetermined value or below, the drive control device controls to drive the stepping motor by a drive pulse having a predetermined polarity and then stop the driving of the same, and start the driving of the stepping motor by a drive pulse having a polarity opposite from the predetermined polarity when restarting the driving after the source voltage is restored.

5. The stepping motor control circuit according to claim 4, wherein the drive pulse having the predetermined polarity is the correction drive pulse having the predetermined polarity.

6. The stepping motor control circuit according to claim 1, wherein the drive pulse having the predetermined energy is a main drive pulse of a maximum energy rank.

7. The stepping motor control circuit according to claim 2, wherein the drive pulse having the predetermined energy is a main drive pulse of a maximum energy rank.

8. The stepping motor control circuit according to claim 3, wherein the drive pulse having the predetermined energy is a main drive pulse of a maximum energy rank.

9. The stepping motor control circuit according to claim 4, wherein the drive pulse having the predetermined energy is a main drive pulse of a maximum energy rank.

10. The stepping motor control circuit according to claim 5, wherein the drive pulse having the predetermined energy is a main drive pulse of a maximum energy rank.

11. The stepping motor control circuit according to claim 1, wherein the power source is a secondary battery.

12. The stepping motor control circuit according to claim 1, wherein the detection segment is divided into a first segment immediately after the driving by the main drive pulse, a second segment after the first segment, and a third segment after the second segment and, in a state of normal load, the first segment corresponds to a segment in which the state of rotation of the rotor in the normal direction is determined and a segment in which the first state of reverse rotation is determined in a third quadrant of the space around the rotor, the second segment corresponds to a segment in which the first state of reverse rotation of the rotor is determined in the third quadrant, and the third segment corresponds to a segment in which the state of rotation after the first reverse rotation of the rotor is determined in the third quadrant, and
the drive control device determines whether or not the power source is lowered to the predetermined voltage value or below on the basis of the pattern of a segment in which the rotation detection device detects the induced signal exceeding the reference threshold voltage.

13. The stepping motor control circuit according to claim 2, wherein the detection segment is divided into a first segment immediately after the driving by the main drive pulse, a second segment after the first segment, and a third segment after the second segment and, in a state of normal load, the first segment corresponds to a segment in which the state of rotation of the rotor in the normal direction is determined and a segment in which the first state of reverse rotation is determined in a third quadrant of the space around the rotor, the second segment corresponds to a segment in which the first state of reverse rotation of the rotor is determined in the third quadrant, and the third segment corresponds to a segment in which the state of rotation after the first reverse rotation of the rotor is determined in the third quadrant, and
the drive control device determines whether or not the power source is lowered to the predetermined voltage value or below on the basis of the pattern of a segment in which the rotation detection device detects the induced signal exceeding the reference threshold voltage.

14. The stepping motor control circuit according to claim 3, wherein the detection segment is divided into a first segment immediately after the driving by the main drive pulse, a second segment after the first segment, and a third segment after the second segment and, in a state of normal load, the first segment corresponds to a segment in which the state of rotation of the rotor in the normal direction is determined and a segment in which the first state of reverse rotation is determined in a third quadrant of the space around the rotor, the second segment corresponds to a segment in which the first state of reverse rotation of the rotor is determined in the third quadrant, and the third segment corresponds to a segment in which the state of rotation after the first reverse rotation of the rotor is determined in the third quadrant, and
the drive control device determines whether or not the power source is lowered to the predetermined voltage value or below on the basis of the pattern of a segment in which the rotation detection device detects the induced signal exceeding the reference threshold voltage.

15. The steppingmotor control circuit according to claim 4, wherein the detection segment is divided into a first segment immediately after the driving by the main drive pulse, a second segment after the first segment, and a third segment after the second segment and, in a state of normal load, the first segment corresponds to a segment in which the state of rotation of the rotor in the normal direction is determined and a segment in which the first state of reverse rotation is determined in a third quadrant of the space around the rotor, the second segment corresponds to a segment in which the first state of reverse rotation of the rotor is determined in the third quadrant, and the third segment corresponds to a segment in which the state of rotation after the first reverse rotation of the rotor is determined in the third quadrant, and
the drive control device determines whether or not the power source is lowered to the predetermined voltage value or below on the basis of the pattern of a segment in which the rotation detection device detects the induced signal exceeding the reference threshold voltage.

16. The stepping motor control circuit according to claim 5, wherein the detection segment is divided into a first segment immediately after the driving by the main drive pulse, a second segment after the first segment, and a third segment after the second segment and, in a state of normal load, the first segment corresponds to a segment in which the state of rotation of the rotor in the normal direction is determined and a segment in which the first state of reverse rotation is determined in a third quadrant of the space around the rotor, the second segment corresponds to a segment in which the first state of reverse rotation of the rotor is determined in the third quadrant, and the third segment corresponds to a segment in which the state of rotation after the first reverse rotation of the rotor is determined in the third quadrant, and
the drive control device determines whether or not the power source is lowered to the predetermined voltage value or below on the basis of the pattern of a segment in which the rotation detection device detects the induced signal exceeding the reference threshold voltage.

17. The stepping motor control circuit according to claim 12, wherein the drive control device determines that the voltage of the power source is lowered to the predetermined voltage value or below when a pattern in which the induced signal exceeding the reference threshold voltage is detected in the first segment or a pattern in which the induced signal exceeding the reference threshold voltage is not detected in the first segment and the second segment is obtained in a case where the stepping motor is driven by the main drive pulse of the maximum energy rank.

18. The stepping motor control circuit according to claim 1, wherein when the drive control device selects the main drive pulse of the maximum energy rank to drive the stepping motor, the drive control device drives the stepping motor in a first mode different from the mode at the time of normal driving.

19. The stepping motor control circuit according to claim 18, wherein the drive control device drives the stepping motor in a second mode different from the mode at the time of the normal driving and the first mode when the a pattern in which the induced signal exceeding the reference threshold voltage is detected only in the first segment and the third segment is obtained in a case where the stepping motor is driven by the main drive pulse of the maximum energy rank.

20. An analogue electronic watch having a stepping motor configured to rotate time-of-day hands, and a stepping motor control circuit configured to control driving of the stepping motor,
wherein the stepping motor control circuit according to claim 1 is used as the stepping motor control circuit.
